(19) United States
(12) Patent Application Publication
(10) Pub. No.: US 2007/0229950 A1
(43) Pub. Date: Oct. 4, 2007

(54) REINFORCED OPTICAL FILMS

(75) Inventors: Andrew J. Ouderkirk, Woodbury, MN (US); Shandon D. Hart, Mapiewood, MN (US); Olester Benson, Woodbury, MN (US); Patrick R. Fleming, Lake Elmo, MN (US); Kristin L. Thunhorst, Stillwater, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/625,869

(22) Filed: Jan. 23, 2007

Related U.S. Application Data
(63) Continuation of application No. 11/278,346, filed on Mar. 31, 2006.

(51) Int. Cl. G03B 21/60

(52) U.S. Cl. 359/454

(57) ABSTRACT

Optical films having structured surfaces are used, inter alia, for managing the propagation of light within a display. As displays become larger, it becomes more important that the film be reinforced so as to maintain rigidity. An optical film of the invention has a first layer comprising inorganic fibers embedded within a polymer matrix. A second layer having a structured surface, for providing an optical function to light passing therethrough, is attached to the first layer. The film may have various beneficial optical properties, for example, light that propagates substantially perpendicularly through the first layer may be subject to no more than a certain level of haze or light incident on the film may be subject to a minimum value of brightness gain. Various methods of manufacturing the films are described.

### RELATED APPLICATIONS

The present application is a continuation of U.S. patent application Ser. No. 11/278346, filed on Mar. 31, 2006, the entirety of which is incorporated by reference herein.

### FIELD OF THE INVENTION

The invention relates to optical films and more particularly to optical films with structured surfaces that may be used in a display, for example a liquid crystal display.

### BACKGROUND

Optical films, such as films having a structured refractive surface, are often used in displays, for example, for managing the propagation of light from a light source to a display panel. For example, a prismatic brightness enhancing film is often used to increase the amount of on-axis light from a display.

As display systems increase in size, the area of the films also becomes larger. Such surface structured films are thin, typically tens or a few hundreds of microns thick and, therefore, have little structural integrity, especially when used in larger display systems. For example, while a film of a certain thickness may be sufficiently rigid for use in a cell phone display, that same film may well be insufficiently rigid for use in a larger display such as a television or computer monitor, without some additional means of support. Stiffer films should also make large display system assembly processes less laborious and potentially more automated, reducing the final assembled cost of the display.

The surface structured film can be made to be thicker, in order to provide additional rigidity, or may be laminated to a thick polymer substrate to provide the support needed for use in a large area film. The use of a thick film or a thick substrate, however, increases the thickness of the display unit, and also leads to increases in the weight and, possibly, in the optical absorption. The use of a thicker film or substrate also increases thermal insulation, reducing the ability to transfer heat out of the display. Furthermore, there are continuing demands for displays with increased brightness, which means that more heat is generated with the display systems. This leads to an increase in the distorting effects that are associated with higher heating, for example film warping. In addition, the lamination of the surface structured film to a substrate adds cost to the device, and makes the device thicker and heavier. The added cost does not, however, result in a significant improvement in the optical function of the display.

### SUMMARY OF THE INVENTION

One embodiment of the invention is directed to an optical film that has a first layer comprising inorganic fibers embedded within a polymer matrix and a second layer attached to the first layer. The second layer has a structured surface. Light that propagates substantially perpendicularly through the film is subject to a bulk haze of less than 30%.

Another embodiment of the invention is directed to a display system that has a display panel, a backlight and a reinforced film positioned between the display panel and the backlight. The reinforced film has a first layer formed of a polymer matrix with inorganic fibers embedded within the polymer matrix. A second layer is attached to the first layer and has a structured surface. Light that propagates substantially perpendicularly through the reinforced film is subject to a bulk haze of less than 30%.

Another embodiment of the invention is directed to a method of manufacturing an optical film. The method includes providing a first layer having a structured surface and providing a fiber reinforced layer comprising inorganic fibers embedded within a polymer matrix. Light propagating through the fiber reinforced layer is subject to a bulk haze of less than 30%. The fiber reinforced layer is attached to the first layer.

Another embodiment of the invention is directed to an optical film that comprises a first layer. The first layer comprises inorganic fibers embedded within a polymer matrix. A second layer that is attached to the first layer has a structured surface. The film provides a brightness gain of at least 10% to light that propagates through the film.

Another embodiment of the invention is directed to an optical film that includes a first layer having inorganic fibers embedded within a polymer matrix, and a second layer. The second layer has a structured surface. Single pass transmission for light, substantially normally incident on a side of the film facing away from the structured surface, is less than 40%.

The above summary of the present invention is not intended to describe each illustrated embodiment or every implementation of the present invention. The following figures and the detailed description more particularly exemplify these embodiments.

### BRIEF DESCRIPTION OF THE DRAWINGS

The invention may be more completely understood in consideration of the following detailed description of various embodiments of the invention in connection with the accompanying drawings, in which:

FIG. 1 schematically illustrates a display system that uses a surface structured film according to principles of the present invention;

FIG. 2A schematically illustrates an exemplary embodiment of a fiber reinforced, surface structured film having a reinforced layer attached directly to a surface structured layer, according to principles of the present invention;

FIG. 2B schematically illustrates an exemplary embodiment of a fiber reinforced surface structured film having a reinforced layer attached to a surface structured layer via an adhesive layer, according to principles of the present invention;

FIG. 3 schematically illustrates an embodiment of a system for manufacturing a fiber reinforced surface structured film, according to principles of the present invention;

FIG. 4 schematically illustrates another embodiment of a system for manufacturing a fiber reinforced surface structured film, according to principles of the present invention;

FIG. 5 schematically illustrates another embodiment of a system for manufacturing a fiber reinforced surface structured film, according to principles of the present invention;

FIG. 6 schematically illustrates an embodiment of a reinforced surface structured film having two reinforced layers, according to principles of the present invention;

FIGS. 7A-7F schematically illustrate different embodiments of reinforced surface structured films, according to principles of the present invention;

FIG. 8 schematically illustrates an embodiment of a reinforced surface structured film that includes an attached optical layer, according to principles of the present invention;

FIG. 9 schematically illustrates an embodiment of a reinforced surface structured film with an attached reflector, according to principles of the present invention;

FIG. 10 schematically illustrates an embodiment of a reinforced surface structured film with an attached polarizer layer, according to principles of the present invention;

FIG. 11 schematically illustrates another embodiment of a reinforced surface structured film, according to principles of the present invention

FIGS. 12A, 12B and 13 schematically illustrate embodiments of reinforced surface structured films that include two surface structured layers, according to principles of the present invention.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION

The present invention is applicable to optical systems and is particularly applicable to optical display systems that use one or more optical films. As optical displays, for example liquid crystal displays (LCDs), become larger and brighter, the demands on optical films within the displays become greater. Larger displays require stiffer films, to prevent warping, bending and sagging. Scaling a film's thickness up with its length and width, however, leads to a thicker and heavier film. It is desirable, therefore, that optical films be made stiffer so that they can be used in large displays, without a concomitant increase in thickness. One approach for increasing the stiffness of an optical film is to include reinforcing fibers within the film. In some exemplary embodiments, the fibers are matched in refractive index to the surrounding material of the film so that there is little, or no, scatter of the light passing through the film. Although it may be desirable in many applications that the composite optical films are thin, e.g. less than ˜0.2 mm, there is no particular limitation to the thickness. In some embodiments it may be desirable to combine the advantages of composite materials and greater thickness, for example creating thick plates used in LCD-TV's that could be 0.2-10 mm thick. For the purposes of this application, the term ‘optical film’ should be considered to include these thicker optical plates or lightguides.

In some exemplary embodiments of the present invention, a surface structured film includes a surface structured layer that is attached to a fiber reinforced layer. This arrangement permits the surface structured film to be made larger in area while maintaining a rigid form that does not significantly deflect or warp under operating conditions in larger displays.

A schematic exploded view of an exemplary embodiment of a display system 100 that may include the invention is presented in FIG. 1. Such a display system 100 may be used, for example, in a liquid crystal display (LCD) monitor or LCD-TV. The display system 100 is based on the use of an LC panel 102, which typically comprises a layer of liquid crystal (LC) 104 disposed between panel plates 106. The plates 106 are often formed of glass, and may include electrode structures and alignment layers on their inner surfaces for controlling the orientation of the liquid crystals in the LC layer 104. The electrode structures are commonly arranged so as to define LC panel pixels, areas of the LC layer where the orientation of the liquid crystals can be controlled independently of adjacent areas. A color filter may also be included with one or more of the plates 106 for imposing color on the image displayed.

An upper absorbing polarizer 108 is positioned above the LC layer 104 and a lower absorbing polarizer 110 is positioned below the LC layer 104. In the illustrated embodiment, the upper and lower absorbing polarizers 108, 110 are located outside the LC panel 102. The absorbing polarizers 108, 110 and the LC panel 102 in combination control the transmission of light from a backlight 112 through the display system 100 to the viewer.

The backlight 112 includes a number of light sources 116 that generate the light that illuminates the LC panel 102. The light sources 116 used in an LCD-TV or LCD monitor are often linear, cold cathode, fluorescent tubes that extend across the display device 100. Other types of light sources may be used, however, such as filament or arc lamps, light emitting diodes (LEDs), flat fluorescent panels or external fluorescent lamps. This list of light sources is not intended to be limiting or exhaustive, but only exemplary.

The backlight 112 may also include a reflector 118 for reflecting light propagating downwards from the light sources 116, in a direction away from the LC panel 102. The reflector 118 may also be useful for recycling light within the display device 100, as is explained below. The reflector 118 may be a specular reflector or may be a diffuse reflector. One example of a specular reflector that may be used as the reflector 118 is Vikuiti™ Enhanced Specular Reflection (ESR) film available from 3M Company, St. Paul, Minn. Examples of suitable diffuse reflectors include polymers, such as polyethylene terephthalate (PET), polycarbonate (PC), polypropylene, polystyrene and the like, loaded with diffusely reflective particles, such as titanium dioxide, barium sulphate, calcium carbonate and the like. Other examples of diffuse reflectors, including microporous materials and fibril-containing materials, are discussed in co-owned U.S. Patent Application Publication 2003/0118805 A1, incorporated herein by reference.

An arrangement 120 of light management layers is positioned between the backlight 112 and the LC panel 102. The light management layers affect the light propagating from backlight 112 so as to improve the operation of the display device 100. For example, the arrangement 120 of light management layers may include a diffuser layer 122. The diffuser layer 122 is used to diffuse the light received from the light sources, which results in an increase in the uniformity of the illumination light incident on the LC panel 102. Consequently, this results in an image perceived by the viewer that is more uniformly bright.

The arrangement 120 of light management layers may also include a reflective polarizer 124. The light sources 116 typically produce unpolarized light but the lower absorbing polarizer 110 only transmits a single polarization state, and so about half of the light generated by the light sources 116 is not transmitted through to the LC layer 104. The reflecting polarizer 124, however, may be used to reflect the light that would otherwise be absorbed in the lower absorbing polarizer, and so this light may be recycled by reflection between the reflecting polarizer 124 and the reflector 118. At least some of the light reflected by the reflecting polarizer 124 may be depolarized, and subsequently returned to the reflecting polarizer 124 in a polarization state that is transmitted through the reflecting polarizer 124 and the lower absorbing polarizer 110 to the LC layer 104. In this manner, the reflecting polarizer 124 may be used to increase the fraction of light emitted by the light sources 116 that reaches the LC layer 104, and so the image produced by the display device 100 is brighter.

Any suitable type of reflective polarizer may be used, for example, multilayer optical film (MOF) reflective polarizers; diffusely reflective polarizing film (DRPF), such as continuous/disperse phase polarizers or cholesteric reflective polarizers.

The MOF, cholesteric and continuous/disperse phase reflective polarizers rely on the varying refractive index profile within a material, usually polymeric material, to selectively reflect light of one polarization state while transmitting light in an orthogonal polarization state. Some examples of MOF reflective polarizers are described in co-owned U.S. Pat. No. 5,882,774, incorporated herein by reference. Commercially available examples of MOF reflective polarizers include Vikuiti™ DBEF-II and DBEF-D400 multilayer reflective polarizers that include diffusive surfaces, available from 3M Company, St. Paul, Minn.

Examples of DRPF useful in connection with the present invention include continuous/disperse phase reflective polarizers as described in co-owned U.S. Pat. No. 5,825,543, incorporated herein by reference, and diffusely reflecting multilayer polarizers as described in, e.g. U.S. Pat. No. 5,867,316, also incorporated herein by reference. Other suitable types of DRPF are described in U.S. Pat. No. 5,751,388.

Some examples of cholesteric polarizer useful in connection with the present invention include those described, for example, in U.S. Pat. No. 5,793,456, and U.S. Patent Publication No. 2002/0159019. Cholesteric polarizers are often provided along with a quarter wave retarding layer on the output side, so that the light transmitted through the cholesteric polarizer is converted to linear polarization.

The arrangement 120 of light management layers may also include a prismatic brightness enhancing layer 128. A brightness enhancing layer is one that includes a surface structure that redirects off-axis light in a direction closer to the axis of the display. This increases the amount of light propagating on-axis through the LC layer 104, thus increasing the brightness of the image seen by the viewer. One example is a prismatic brightness enhancing layer, which has a number of prismatic elements that redirect the illumination light, through refraction and reflection. Examples of prismatic brightness enhancing layers that may be used in the display device include the Vikuiti™ BEFII and BEFIII family of prismatic films available from 3M Company, St. Paul, Minn., including BEFII 90/24, BEFII 90/50, BEFIIIM 90/50, and BEFIIIT. The prismatic elements may be formed as ridges that extend across the width of the film, or as shorter elements.

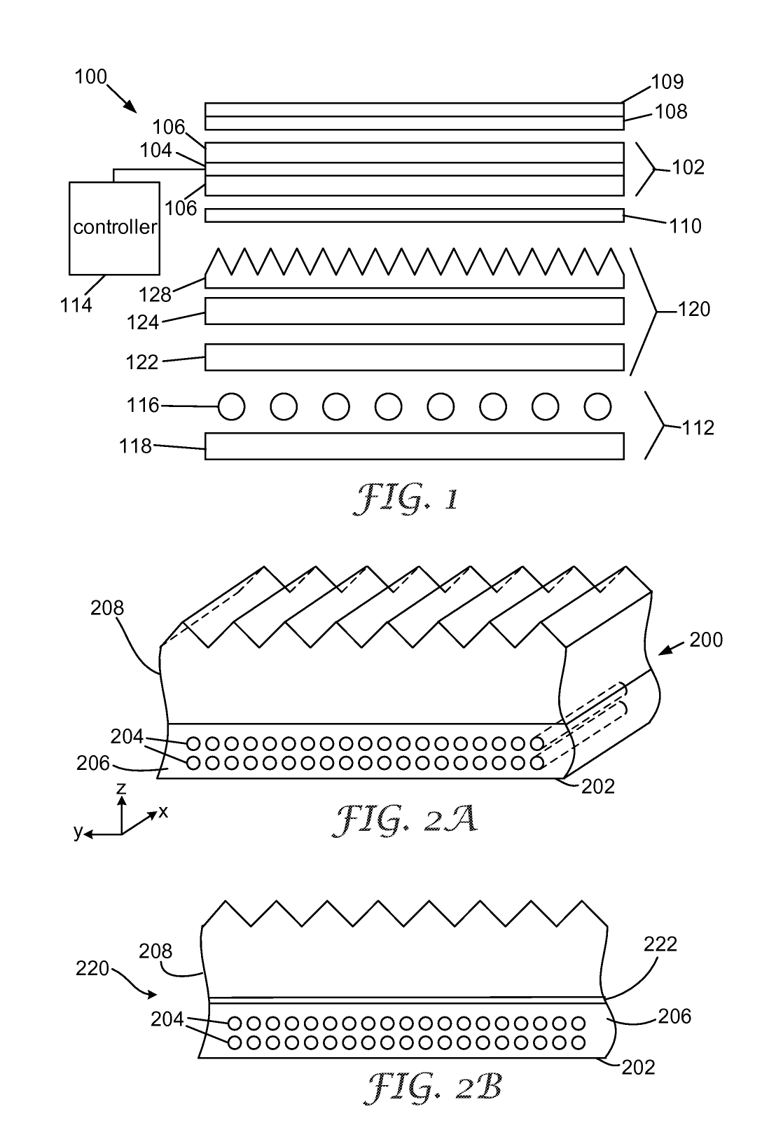

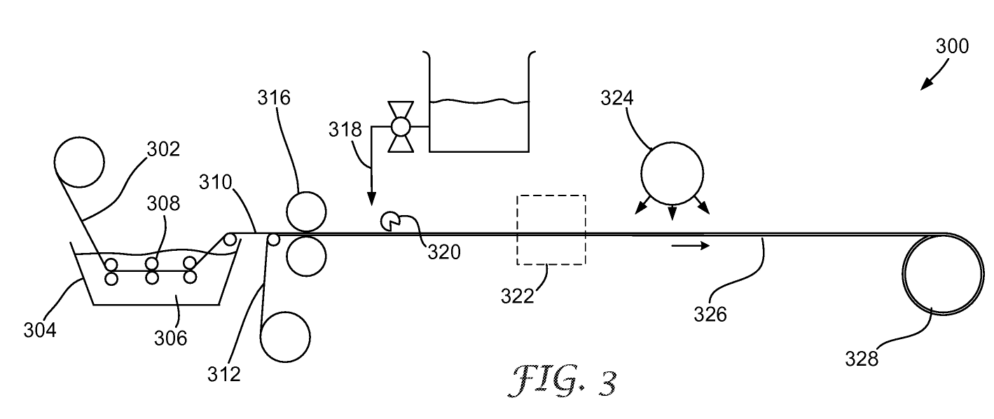

An exemplary embodiment of a reinforced brightness enhancing film 200 is schematically illustrated in FIG. 2A. The reinforced film 200 includes a reinforcing layer 202 attached to a brightness enhancing layer 208. The brightness enhancing layer 208 may include any type of surface structured layer having structure for redirecting light to propagate in a direction close to the display axis. The reinforcing layer 202 comprises a composite arrangement of inorganic fibers 204 disposed within a polymeric matrix 206.

The inorganic fibers 204 may be formed of glass, ceramic or glass-ceramic materials, and may be arranged within the matrix 206 as individual fibers, in one or more tows or in one or more woven layers. The fibers 204 may be arranged in a regular pattern or an irregular pattern. Several different embodiments of reinforced polymeric layers are discussed in greater detail in U.S. patent application Ser. No. 11/125,580, filed on May 10, 2005, incorporated herein by reference.

The refractive indices of the matrix 206 and the fibers 204 may be chosen to match or not match. In some exemplary embodiments, it may be desirable to match the refractive indices so that the resulting article is nearly, or completely, transparent to the light from the light source. In other exemplary embodiments, it may be desirable to have an intentional mismatch in the refractive indices to create either specific color scattering effects or to create diffuse transmission or reflection of the light incident on the film. Refractive index matching can be achieved by selecting an appropriate fiber 204 reinforcement that has an index close to the same as that of the resin matrix 206, or by creating a resin matrix that has a refractive index close to, or the same as, that of the fibers 204.

The refractive indices in the x-, y-, and z-directions for the material forming the polymer matrix 206 are referred to herein as n₁ₓ, n_{1y} and n_{1z}. Where the polymer matrix material 206 is isotropic, the x-, y-, and z-refractive indices are all substantially matched. Where the matrix material is birefringent, at least one of the x-, y- and z- refractive indices is different from the others. The material of the fibers 204 is typically isotropic. Accordingly, the refractive index of the material forming the fibers is given as n₂. The fibers 204 may, however, be birefringent.

In some embodiments, it may be desired that the polymer matrix 206 be isotropic, i.e. n₁ₓ≈n_{1y}≈n_{1z}≈n₁. Two refractive indices are considered to be substantially the same if the difference between the two indices is less than 0.05, preferably less than 0.02 and more preferably less than 0.01. Thus, the material is considered to be isotropic if no pair of refractive indices differs by more than 0.05, preferably less than 0.02. Furthermore, in some embodiments it is desirable that the refractive indices of the matrix 206 and the fibers 204 be substantially matched. Thus, the refractive index difference between the matrix 206 and the fibers 204, the difference between n₁ and n₂ should be small, at least less than 0.02, preferably less than 0.01 and more preferably less than 0.002.

In other embodiments, it may be desired that the polymer matrix be birefringent, in which case at least one of the matrix refractive indices is different from the refractive index of the fibers 204. In embodiments where the fibers 204 are isotropic, a birefringent matrix results in light in at least one polarization state being scattered by the reinforcing layer. The amount of scattering depends on several factors, including the magnitude of the refractive index difference for the polarization state being scattered, the size of the fibers 204 and the density of the fibers 204 within the matrix 206. Furthermore, the light may be forward scattered (diffuse transmission), backscattered (diffuse reflection), or a combination of both. Scattering of light by a fiber reinforced layer 202 is discussed in greater detail in U.S. patent application Ser. No. 11/125,580.

Suitable materials for use in the polymer matrix 206 include thermoplastic and thermosetting polymers that are transparent over the desired range of light wavelengths. In some embodiments, it may be particularly useful that the polymers be non-soluble in water, the polymers may be hydrophobic or may have a low tendency for water absorption. Further, suitable polymer materials may be amorphous or semi-crystalline, and may include homopolymer, copolymer or blends thereof. Example polymer materials include, but are not limited to, poly(carbonate) (PC); syndiotactic and isotactic poly(styrene) (PS); C1-C8 alkyl styrenes; alkyl, aromatic, and aliphatic ring-containing (meth)acrylates, including poly(methylmethacrylate) (PMMA) and PMMA copolymers; ethoxylated and propoxylated(meth)acrylates; multifunctional (meth)acrylates; acrylated epoxies; epoxies; and other ethylenically unsaturated materials; cyclic olefins and cyclic olefinic copolymers; acrylonitrile butadiene styrene (ABS); styrene acrylonitrile copolymers (SAN); epoxies; poly(vinylcyclohexane); PMMA/poly(vinylfluoride) blends; poly(phenylene oxide) alloys; styrenic block copolymers; polyimide; polysulfone; poly(vinyl chloride); poly(dimethyl siloxane) (PDMS); polyurethanes; saturated polyesters; poly(ethylene), including low birefringence polyethylene; poly(propylene) (PP); poly(alkane terephthalates), such as poly(ethylene terephthalate) (PET); poly(alkane napthalates), such as poly(ethylene naphthalate)(PEN); polyamide; ionomers; vinyl acetate/polyethylene copolymers; cellulose acetate; cellulose acetate butyrate; fluoropolymers; poly(styrene)-poly(ethylene) copolymers; PET and PEN copolymers, including polyolefinic PET and PEN; and poly(carbonate)/aliphatic PET blends. The term (meth)acrylate is defined as being either the corresponding methacrylate or acrylate compounds. These polymers may be used in an optically isotropic form.

In some product applications, it is important that film products and components exhibit low levels of fugitive species (low molecular weight, unreacted, or unconverted molecules, dissolved water molecules, or reaction byproducts). Fugitive species can be absorbed from the end-use environment of the product or film, e.g. water molecules can be present in the product or film from the initial product manufacturing or can be produced as a result of a chemical reaction (for example a condensation polymerization reaction). An example of small molecule evolution from a condensation polymerization reaction is the liberation of water during the formation of polyamides from the reaction of diamines and diacids. Fugitive species can also include low molecular weight organic materials such as monomers, plasticizers, etc.

Fugitive species are generally lower molecular weight than the majority of the material comprising the rest of the functional product or film. Product use conditions might, for example, result in thermal stress that is differentially greater on one side of the product or film. In these cases, the fugitive species can migrate through the film or volatilize from one surface of the film or product causing concentration gradients, gross mechanical deformation, surface alteration and, sometimes, undesirable out-gassing. The out-gassing could lead to voids or bubbles in the product, film or matrix, or problems with adhesion to other films. Fugitive species can, potentially, also solvate, etch or undesirably affect other components in product applications.

Several of these polymers may become birefringent when oriented. In particular, PET, PEN, and copolymers thereof, and liquid crystal polymers, manifest relatively large values of birefringence when oriented. Polymers may be oriented using different methods, including extrusion and stretching. Stretching is a particularly useful method for orienting a polymer, because it permits a high degree of orientation and may be controlled by a number of easily controllable external parameters, such as temperature and stretch ratio.

The matrix 206 may be provided with various additives to provide desired properties to the film 200. For example, the additives may include one or more of the following: an anti-weathering agent, UV absorbers, a hindered amine light stabilizer, an antioxidant, a dispersant, a lubricant, an anti-static agent, a pigment or dye, a nucleating agent, a flame retardant and a blowing agent.

Some exemplary embodiments may use a polymer matrix material that is resistant to yellowing and clouding with age. For example, some materials such as aromatic urethanes become unstable when exposed long-term to UV light, and change color over time. It may be desired to avoid such materials when it is important to maintain the same color for a long term.

Other additives may be provided to the matrix 206 for altering the refractive index of the polymer or increasing the strength of the material. Such additives may include, for example, organic additives such as polymeric beads or particles and polymeric nanoparticles. In some embodiments, the matrix is formed using a specific ratio of two or more different monomers, where each monomer is associated with a different final refractive index when polymerized. The ratios of the different monomers determine the refractive index of the final resin 206.

In other embodiments, inorganic additives may be added to the matrix 206 to adjust the refractive index of the matrix 206, or to increase the strength and/or stiffness of the material. For example, the inorganic material may be glass, ceramic, glass-ceramic or a metal-oxide. Any suitable type of glass, ceramic or glass-ceramic, discussed below with respect to the inorganic fibers, may be used. Suitable types of metal oxides include, for example, titania, alumina, tin oxides, antimony oxides, zirconia, silica, mixtures thereof or mixed oxides thereof. Such inorganic materials may be provided as nanoparticles, for example milled, powdered, bead, flake or particulate in form, and distributed within the matrix. Nanoparticles may be synthesized, for example, using gas-phase or solution-based processing. The size of the particles is preferably lower than about 200 nm, and may be less than 100 nm or even 50 nm to reduce scattering of the light passing through the matrix 206. The additives may have functionalized surfaces to optimize the dispersion and/or the rheology and other fluid properties of the suspension, or to react with the polymer matrix. Other types of particles include hollow shells, for example hollow glass shells.

Any suitable type of inorganic material may be used for the fibers 204. The fibers 204 may be formed of a glass that is substantially transparent to the light passing through the film. Examples of suitable glasses include glasses often used in fiberglass composites such as E, C, A, S, R, and D glasses. Higher quality glass fibers may also be used, including, for example, fibers of fused silica and BK7 glass. Suitable higher quality glasses are available from several suppliers, such as Schott North America Inc., Elmsford, N.Y. It may be desirable to use fibers made of these higher quality glasses because they are purer and so have a more uniform refractive index and have fewer inclusions, which leads to less scattering and increased transmission. Also, the mechanical properties of the fibers are more likely to be uniform. Higher quality glass fibers are less likely to absorb moisture, and thus the film becomes more stable for long term use. Furthermore, it may be desirable to use a low alkali glass, since alkali content in glass increases the absorption of water.

Discontinuous reinforcements, such as particles or chopped fibers, may be preferred in polymers that need stretching or in certain other forming processes. Extruded thermoplastics filled with chopped glass, for example, as described in U.S. patent application Ser. No. 11/323,726, incorporated herein by reference, may be used as the fiber-filled reinforcing layer. For other applications, continuous glass fiber reinforcements (i.e. weaves or tows) may be preferred since these can lead to a larger reduction in the coefficient of thermal expansion (CTE) and a greater increase in modulus.

Another type of inorganic material that may be used for the fiber 204 is a glass-ceramic material. Glass-ceramic materials generally comprise 95%-98% vol. of very small crystals, with a size smaller than 1 micron. Some glass-ceramic materials have a crystal size as small as 50 nm, making them effectively transparent at visible wavelengths, since the crystal size is so much smaller than the wavelength of visible light that virtually no scattering takes place. These glass-ceramics can also have very little, or no, effective difference between the refractive index of the glassy and crystalline regions, making them visually transparent. In addition to the transparency, glass-ceramic materials can have a rupture strength exceeding that of glass, and some types are known to have coefficients of thermal expansion of zero or that are even negative in value. Glass-ceramics of interest have compositions including, but not limited to, Li₂O—Al₂O₃—SiO₂, CaO—Al₂O₃—SiO₂, Li₂O—MgO—ZnO—Al₂O₃—SiO₂, Al₂O₃—SiO₂, and ZnO—Al₂O₃—ZrO₂—SiO₂, Li₂O—Al₂O₃—SiO₂, and MgO—Al₂O₃—SiO₂.

Some ceramics also have crystal sizes that are sufficiently small that they can appear transparent if they are embedded in a matrix polymer with an index of refraction appropriately matched. The Nextel™ Ceramic fibers, available from 3M Company, St. Paul, Minn., are examples of this type of material, and are available as thread, yarn and woven mats. Suitable ceramic or glass-ceramic materials are described further in Chemistry of Glasses, 2^{nd} Edition (A. Paul, Chapman and Hall, 1990) and Introduction to Ceramics, 2^{nd} Edition (W. D. Kingery, John Wiley and Sons, 1976), the relevant portions of both of which are incorporated herein by reference.

In some exemplary embodiments, it may be desirable not to have perfect refractive index matching between the matrix 206 and the fibers 204, so that at least some of the light is diffused by the fibers 204. In such embodiments, either or both of the matrix 206 and fibers 204 may be birefringent, or both the matrix and the fibers may be isotropic. Depending on the size of the fibers 204, the diffusion arises from scattering or from simple refraction. Diffusion by a fiber is non-isotropic: light may be diffused in a direction lateral to the axis of the fiber, but is not diffused in an axial direction relative to the fiber. Accordingly, the nature of the diffusion is dependent on the orientation of the fibers within the matrix. If the fibers are arranged, for example, parallel to the x-axis, then the light is diffused in directions parallel to the y- and z-axes.

In addition, the matrix 206 may be loaded with diffusing particles that isotropically scatter the light. Diffusing particles are particles of a different refractive index than the matrix, often a higher refractive index, having a diameter up to about 10 μm. These can also provide structural reinforcement to the composite material. The diffusing particles may be, for example, metal oxides such as were described above for use as nanoparticles for tuning the refractive index of the matrix. Other suitable types of diffusing particles include polymeric particles, such as polystyrene or polysiloxane particles, or a combination thereof. The diffusing particles may also be hollow glass spheres such as type S60HS Glass Bubbles, produced by 3M Company, St. Paul, Minn. The diffusing particles may be used alone to diffuse the light, or may be used along with non-index-matched fibers to diffuse the light, or may be used in conjunction with the structured surface to diffuse and re-direct light.

Some exemplary arrangements of fibers 204 within the matrix 206 include yarns, tows of fibers or yarns arranged in one direction within the polymer matrix, a fiber weave, a non-woven, chopped fiber, a chopped fiber mat (with random or ordered formats), or combinations of these formats. The chopped fiber mat or nonwoven may be stretched, stressed, or oriented to provide some alignment of the fibers within the nonwoven or chopped fiber mat, rather than having a random arrangement of fibers. Furthermore, the matrix 206 may contain multiple layers of fibers 204: for example the matrix 206 may include more layers of fibers in different tows, weaves or the like. In the specific embodiment illustrated in FIG. 2A, the fibers 204 are arranged in two layers.

In another exemplary embodiment of a reinforced film 220, schematically illustrated in FIG. 2B, a layer of adhesive 222 is provided between the structured surface layer 208 and the fiber reinforcement layer 202. The adhesive 222 may be any suitable type of adhesive, for example a pressure sensitive adhesive or a curable laminating adhesive.

One exemplary approach to manufacturing a reinforced surface structured film is now described with reference to FIG. 3. In general, this approach includes applying a matrix resin directly to a pre-prepared surface structured layer. The manufacturing arrangement 300 includes a roll of the fiber reinforcement 302, which is passed through an impregnation bath 304 containing the matrix resin 306. The resin 306 is impregnated into the fiber reinforcement 302 using any suitable method, for example by passing the fiber reinforcement 302 through a series of rollers 308.

Once the impregnated reinforcement 310 is extracted from the bath 304, it is applied to a layer of surface structured film 312 and additional resin 318 may be added if necessary. The impregnated fiber reinforcement 310 and the layer of surface structured film 312 are squeezed together in a pinch roller 316 to ensure good physical contact between the two layers 310 and 312. Optionally, the additional resin 318 may be applied over the reinforcement layer 310, for example using a coater 320. The coater 320 may be any suitable type of coater, for example a knife edge coater, comma coater (illustrated), bar coater, die coater, spray coater, curtain coater, high pressure injection, or the like. Among other considerations, the viscosity of the resin at the application conditions determines the appropriate coating method or methods. The coating method and resin viscosity also affect the rate and extent to which air bubbles are eliminated from the reinforcement during the step where the reinforcement is impregnated with the matrix resin.

Where it is desired that the finished film have low scatter, it is important at this stage to ensure that the resin completely fills the spaces between the fibers: voids or bubbles left in the resin may act as scattering centers. Different approaches may be used, individually or in combination, to reduce the occurrence of bubbles. For example, the film may be mechanically vibrated to encourage the dissemination of the resin 306 throughout the reinforcement layer 310. The mechanical vibration may be applied using, for example, an ultrasonic source. In addition, the film may be subject to a vacuum that extracts the bubbles from the resin 306. This may be performed at the same time as coating or afterwards, for example in an optional de-aeration unit 322.

The resin 306 in the film may then be solidified at a solidification station 324. Solidification includes curing, cooling, cross-linking and any other process that results in the polymer matrix reaching a solid state. In the illustrated embodiment, a radiation source 324 is used to apply radiation to the resin 306. In other embodiments different forms of energy may be applied to the resin 306 including, but not limited to, heat and pressure, electron beam radiation and the like, in order to cure the resin 306. In other embodiments, the resin 306 may be solidified by cooling, polymerization or by cross-linking. In some embodiments, the solidified film 326 is sufficiently supple as to be collected and stored on a take-up roll 328. In other embodiments, the solidified film 326 may be too rigid for rolling, in which case it is stored some other way, for example the film 326 may be cut into sheets for storage.

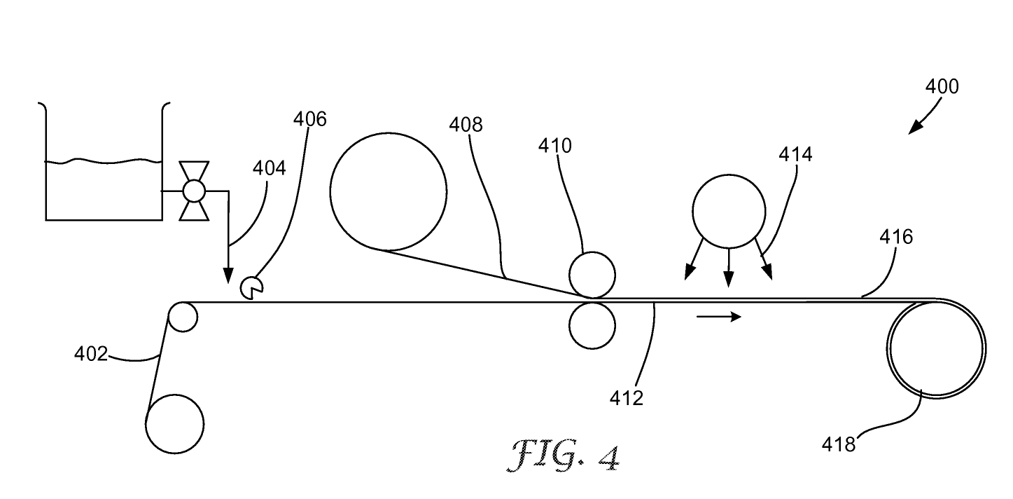

Another approach to making a fiber reinforced surface structured film is to first make the composite on a carrier film from which it will later be separated. The composite can then be used for supporting the surface structured film. In one exemplary embodiment, the composite can be fed into a lamination process with a laminating adhesive and the desired surface structured film. This approach is schematically illustrated in FIG. 4. In this manufacturing system 400, a layer of adhesive 404 is provided on a surface structured film 402. The adhesive 404 may be any suitable type of adhesive useful for laminating two films together. For example, the adhesive may be a pressure sensitive adhesive or a curable laminating adhesive. In the illustrated embodiment, the adhesive 404 is applied as a liquid which is spread to a thin layer using a coater 406. The adhesive layer may itself contain any of the functional elements that could be added to the composite matrix resin, such as UV absorbers or light-diffusing particles.

A pre-prepared, fiber reinforced, composite layer 408 is then laid over the adhesive 406 and the fiber reinforced layer 408 is squeezed together with the surface structured film 402, for example using a pressure roller 410, to form a reinforced laminate 412. If necessary, the adhesive 404 may then be cured, for example though the application of radiation 414. The cured laminate 416 may then be gathered on a roll 418 or cut into sheets for storage.

In a variation of this approach, the adhesive 404 may first be applied to the fiber reinforced layer, and the surface-structure film may then be pressed against the adhesive 404.

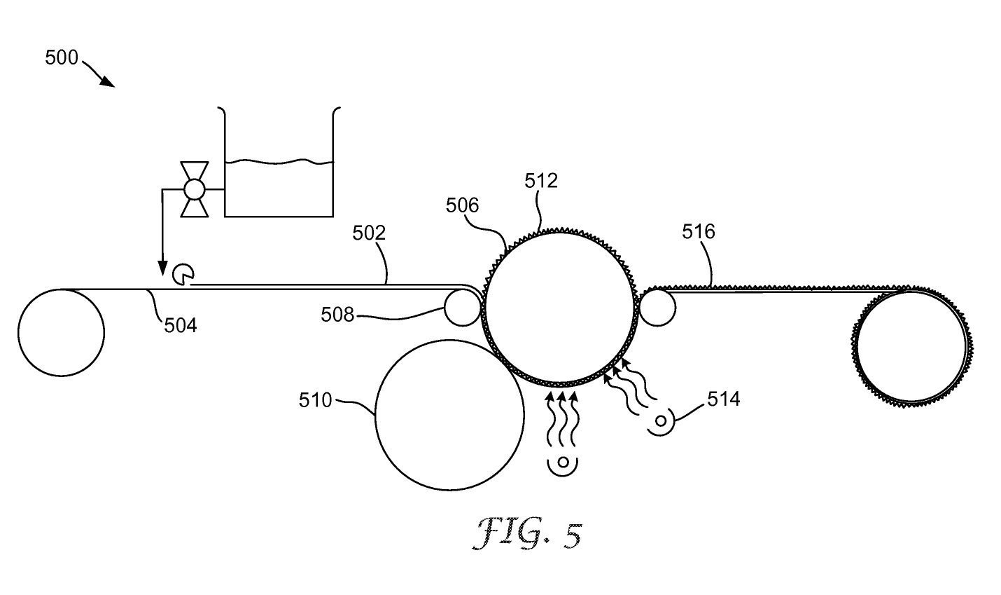

In another exemplary embodiment, a surface-structure film may be cast onto a pre-prepared, fiber reinforced layer. This approach is schematically illustrated in FIG. 5. In this manufacturing system 500, a layer of polymer material 502 is spread onto a fiber reinforced layer 504. The film is then guided to a molding roll 506 by a guiding roll 508 and may optionally be pressed against the molding roll 506 by a pressure roll 510. The molding roll 506 has a shaped surface 512 that is impressed into the coated material 502. The polymer material 502 may be hardened, for example through the application of heat, radiation or the like, while the monomer or polymer material 502 is in contact with the molding roll 506. In the illustrated embodiment, radiation sources 514, such as heat lamps, are used to cure the surface structured layer 516.

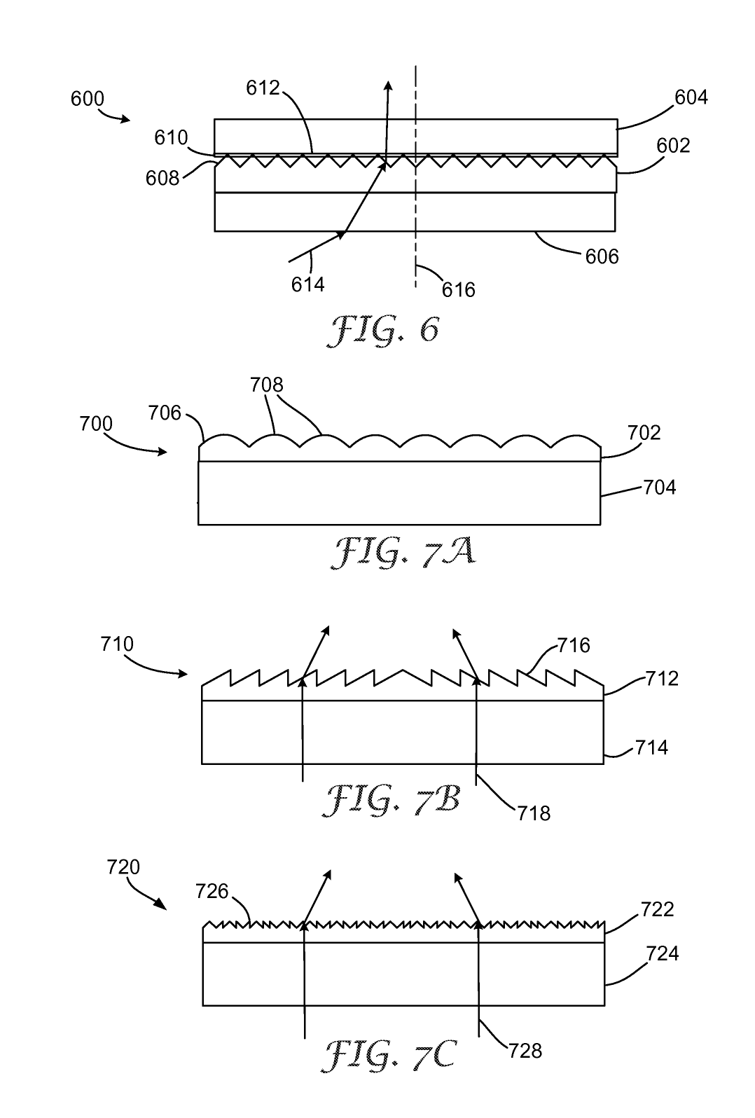

In some exemplary embodiments, a fiber reinforced layer may be attached to each side of a surface structured film. FIG. 6 schematically illustrates an exemplary embodiment of a reinforced surface structured film 600 that has a surface structured layer 602 sandwiched between two fiber reinforcement layers 604, 606. The lower reinforcement layer 606 may be attached using any suitable method, including the different methods discussed above.

The upper reinforcement layer 604 may be attached to the structured surface 608 through the use of an adhesive layer 610 disposed on the lower surface 612 of the reinforcement layer 604. The attachment of the structured surface of a prismatic brightness enhancing layer to another optical film is discussed in greater detail in U.S. Pat. No. 6,846,089, incorporated herein by reference. Generally, the adhesive layer 610 is relatively thin compared to the height of the surface structure. The structured surface 608 is pressed into the adhesive layer to such a depth as to leave a significant portion of the structured surface 608 interfaced with air. This maintains the relatively large refractive index difference between the air and the layer 602, thus conserving the refractive effects of the structured surface 612. It will be appreciated that the structured surface of other types of surface structured films, in addition to a brightness enhancing film, may also be attached to a reinforced layer

The figure also shows the optical path of one exemplary light ray 614 that is redirected by the prismatic brightness enhancing film in a direction more closely aligned with the axis 616. The axis 616 lies normal to the film 600. In some configurations, the light ray 614 may be a principal ray. For the purposes of this application, a principal ray is defined as the ray propagating at the intensity-weighted, central direction of a distributed light beam, where the distributed beam itself may contain multiple rays propagating at different angles. The ray 614 is incident at the film 600 at an angle of more than 30° to the axis 614, and emerges from the film 600 with an angle of less than 25° to the axis 614. In some embodiments, the direction of the principal ray 614 after being transmitted through the film 600 is more than 5° different from the direction of the principal ray 614 before entering the film 600, in other words the film 600 has deviated the ray 614 through an angle of more than 5°, in some embodiments more than 100 and in some embodiments more than 20°.

The structured surface is not restricted to being a brightness enhancing layer and may be any other type of surface. For example, the structured surface may be a lensed surface, a diffusing surface, a diffractive optical surface, a light-turning surface (as used in commercially available “turning” films), or a retroreflecting surface. For certain preferred transmissive light-redirecting applications of the present invention, it is desirable to use non-random structured surfaces that can substantially re-direct a principal ray. For example, a film using such a surface may redirect the principal ray through an angle of 5° or more. Some exemplary structured surfaces are discussed in greater detail below.

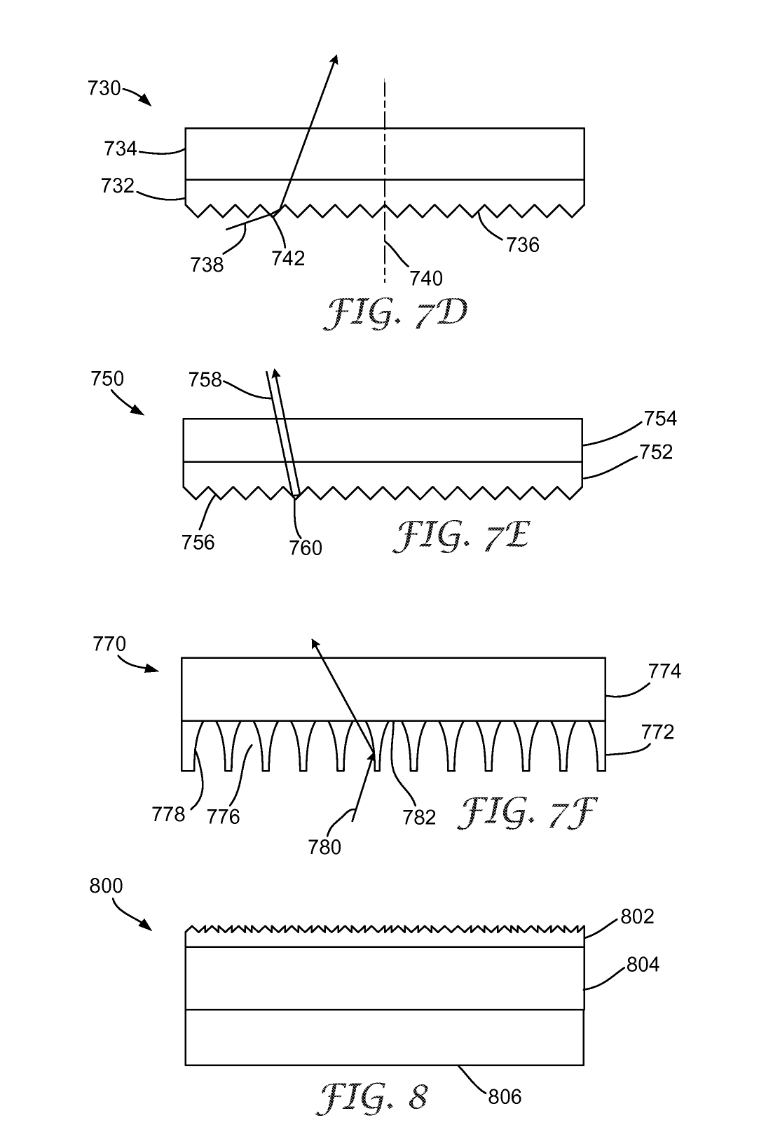

One exemplary type of structured surface is a lensed surface, as is schematically illustrated in FIG. 7A. In this embodiment, a structured surface layer 702 is attached to a reinforced layer 704. The structured surface 706 includes a number of lenses 708 that may be useful for adding optical power to light passing therethrough. There may be any suitable number of lenses, from one to a plurality of lenses. In addition, the lenses may provide positive or negative optical power, and need not all provide the same optical power.

Another type of a lens structured surface is a Fresnel lens. In the exemplary embodiment of a reinforced film 710 schematically illustrated in FIG. 7B, a surface structured layer 712 is attached to a fiber reinforced layer 714. The surface structured layer 712 has a Fresnel surface 716 that focuses light 718 that passes therethrough. In other embodiments, the surface structured layer 712 may include more than one Fresnel lens pattern.

Another type of a structured surface is a diffractive optical surface. In the exemplary embodiment of a reinforced film 720 schematically illustrated in FIG. 7C, a surface structured layer 722 is attached to a fiber reinforced layer 714. The surface structured layer 722 has a diffractive optical surface 726 that diffracts light 728 passing therethrough. It will be appreciated that different types of diffraction may be imparted by the diffractive optical surface 726. For example, in one embodiment, the diffractive optical surface 726 may operate like a lens and provide optical power to the light 728. In other embodiments, the diffractive optical surface may diffract the light differently. For example, the diffractive optical surface may be used to separate light into differently colored components, form patterns such as dot patterns, acts as lenses, or act as shaped diffusers.

Another exemplary embodiment of a reinforced structured surface film is a reinforced turning film 730, schematically illustrated in FIG. 7D. The reinforced turning film 730 includes a turning layer 732 attached to a reinforced layer 734. The turning layer 732 has a structured surface 736 that is directed towards the source of light. Accordingly, light 738 that is incident on the reinforced film 730 at a large angle is redirected by the structured surface along a direction more parallel to the axis 740. In the illustration, the light 738 enters a structural element 742 and is totally internally reflected within the element 742.

Another exemplary embodiment of a reinforced structured surface film is a reinforced retroreflecting film 750, schematically illustrated in FIG. 7E. The reinforced retroreflecting film 750 includes a retroreflecting layer 752 attached to a reinforced layer 754. The retroreflecting layer 752 has a structured surface 756 that is directed away from the source of light. Accordingly, at least some of the light 758 that is incident on the reinforced film 750 may be totally internally reflected by an element 760, which contains two surfaces where total internal reflection takes place. Consequently, the light is retroreflected by the surface 756.

Another exemplary embodiment of a reinforced structured surface film is a reinforced light concentrator film. A light concentrator is a reflective element, typically a non-imaging element, that concentrates light from a larger area to a smaller area. Examples of light concentrators include parabolic reflectors, compound parabolic reflectors and the like. A light concentrator film is a film that contains a number of light concentrators.

In the exemplary embodiment illustrated in FIG. 7F, a light concentrator layer 772 is attached to a fiber reinforced layer 774. The concentrator layer 772 includes a number of reflective collectors 776 that have reflecting sidewalls 778. The light 780 is concentrated at the output apertures 782 of the concentrator layer 772. This can function as a light collimator when operated in the reverse direction, with light directed into the side with the smaller apertures.

Other light management layers having a reinforced layer may be included or attached for purposes other than brightness enhancement. These uses include spatial mixing or color mixing of light, light source hiding, and uniformity improvement. Films that may be used for these purposes include diffusing films, diffusing plates, partially reflective layers, color-mixing lightguides or films, and diffusing systems in which the peak brightness ray of the diffused light propagates in a direction that is not parallel to the direction of the peak brightness ray of the input light.

Other layers may also be attached to a reinforced surface structured layer, for example attached directly to the surface structured layer itself, or to a fiber reinforced layer that is attached to the surface structured layer. A general example of a reinforced surface structured film 800 that includes an additional optical layer is schematically illustrated in FIG. 8. In the illustrated embodiment, the reinforced surface structured layer 800 has a surface structured layer 802 that is attached to a fiber reinforced layer 804. In the illustrated embodiment, an additional optical layer 806 is attached to the fiber reinforced layer 804. The optical layer 806 may be any other type of optical layer that is desired to be attached to the reinforced surface structured layer 800. For example, the optical layer 806 may include an optical layer that is transmissive, diffusive or reflective. A diffusive layer may, for example, include optically diffusive particles dispersed within a matrix. A reflective layer may be a specularly reflective layer, for example a multi-layer film formed from polymer or other dielectric materials. In other exemplary embodiments, the optical layer 806 may be another optical layer that includes a structured refracting surface. Different exemplary types of optical layers with optically functional surfaces include films with prismatic surfaces, films with lensed surfaces, films with diffractive surfaces, diffusive surfaces, and films with optically concentrating surfaces. In other embodiments, the additional optical layer may be a surface structured layer or a reflective polarizer layer.

Other light management layers may be included for purposes other than brightness enhancement. These uses include spatial mixing or color mixing of light, light source hiding, and uniformity improvement. Films that may be used for these purposes include diffusing films, diffusing plates, partially reflective layers, color-mixing lightguides or films, and diffusing systems in which the peak brightness ray of the diffused light propagates in a direction that is not parallel to the direction of the peak brightness ray of the input light.

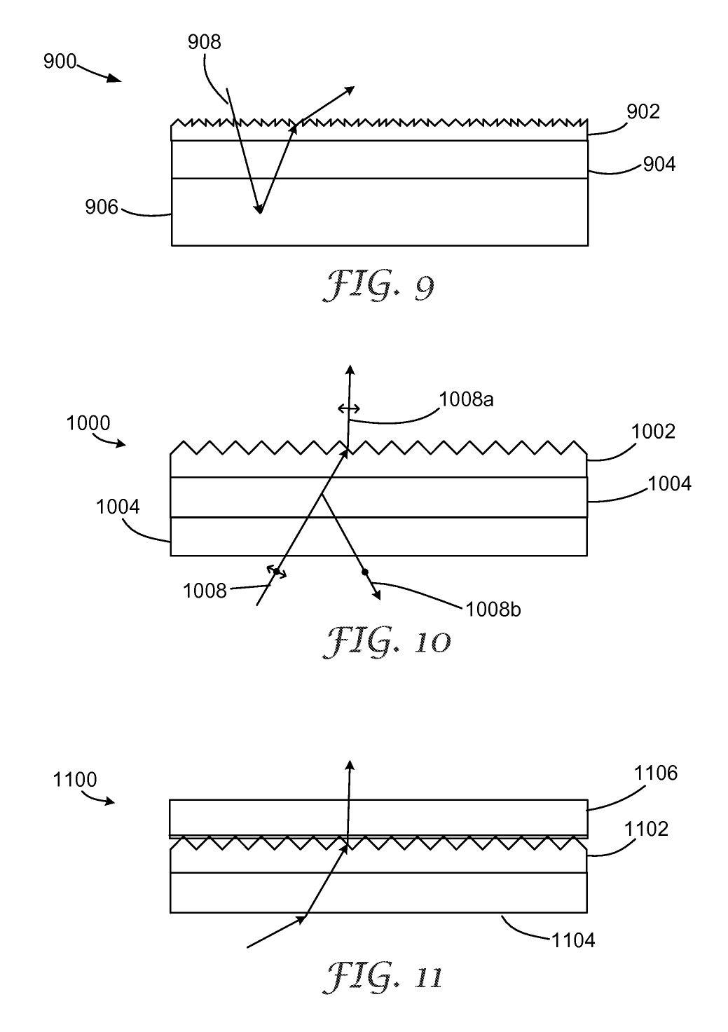

One exemplary embodiment of a type of film that can be attached to a reinforced surface structured film is a reflecting layer. The reflecting layer may be, for example, a diffusive reflecting layer, or may be a specularly reflecting layer. A diffusive reflecting layer may be formed, for example, by loading a film with a high density of diffusing particles. A specularly reflecting layer may be formed, for example, using multiple alternating layers of polymer materials of different refractive indices. FIG. 9 schematically illustrates a reinforced structured surface film 900 having a structured surface layer 902 attached to one side of a reinforcing layer 904. A reflective layer 906 may be attached to the other side of the reinforcing layer 904, as illustrated, or between the reinforcing layer 904 and the structured surface layer 902. Light 908 that passes through the structured surface layer 902 is reflected by the reflective layer 906.

Another exemplary embodiment of a type of film that can be attached to a reinforced surface structured film is a polarizing layer. The polarizing layer may be, for example an absorbing polarizer layer, in which the light in the block polarization state is absorbed, or a reflecting polarizing layer, in which the light in the block polarization state is reflected. One particular embodiment of such a reinforced surface structured film 1000 is schematically illustrated in FIG. 10. In this embodiment, a surface structured layer 1002 is attached to a polarizer layer 1006, which in turn is attached to a reinforced layer 1004. The surface structured layer 1002 is illustrated as a brightness enhancing layer, although other types of surface structured layer may be used. In the illustrated embodiment, the polarizer layer 1006 is a reflective polarizer layer, so that unpolarized light 1008 entering the film 1000 is split into two orthogonally polarized components, a first component 1008a that is transmitted through the film 1000 and a second, orthogonally polarized component 1008b that is reflected from the film 1000. In other embodiments, the reinforced layer 1004 may be positioned between the surface structured layer 1002 and the polarizer layer 1006.

Another embodiment of reinforced film 1100 is schematically illustrated in FIG. 11, in which a surface structured layer 1102 is attached to a fiber reinforced layer 1104 and a polarizing layer 1106 is attached to the structured surface of the surface structured layer 1102.

Where the polarizing layer 1106 is an absorbing polarizer, any suitable type of absorbing polarizer layer may be used, including H type iodine based polarizers, K type intrinsic absorbing polarizers, dye based polarizers and the like. Where the polarizing layer 1106 is a reflecting polarizer, any suitable type of reflecting polarizer may be used, including multilayer optical film (MOF) polarizers, and diffusing polarizers such as DRPF polarizers.

In some embodiments that include polarizers, it may be desirable that the other layer(s) in the system exhibit low and uniform birefringence so as not to disrupt the function of the polarizer layer. An example of this is when a surface structured layer is placed on top of a reflective polarizer, and this combined element is used for brightness enhancement in an LCD display. In this case it is generally desirable to maintain the dominant polarization state that is passed through the reflective polarizer upon transmission through the structured layer. This is one advantage of glass-reinforced thermoset layers, which can be made to have very low birefringence.

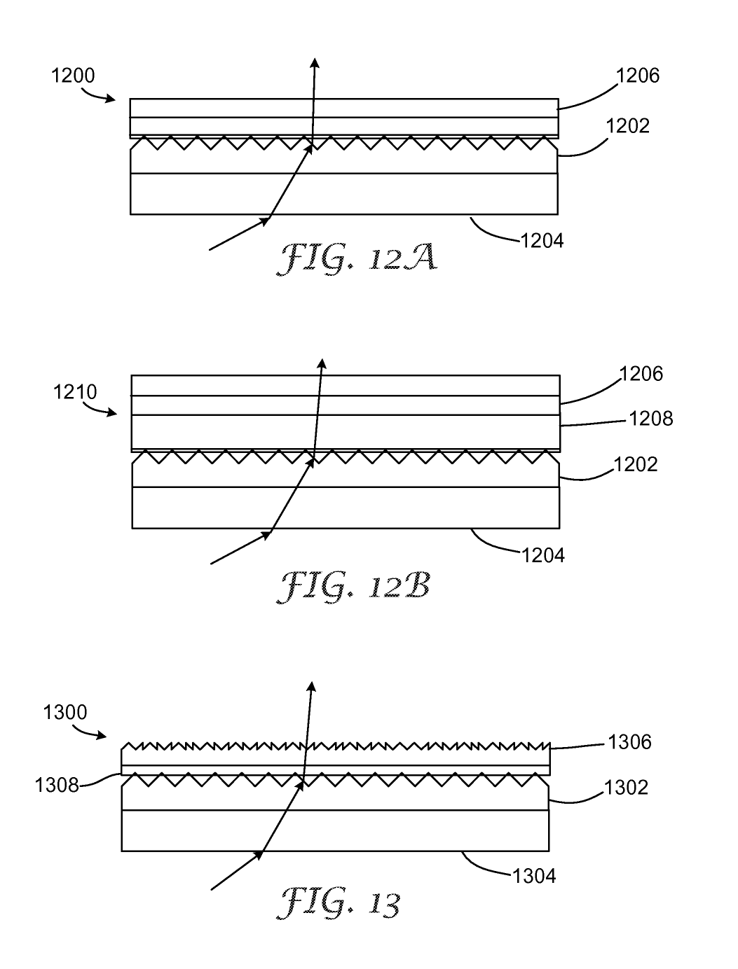

In some other embodiments, two or more surface structured layers may be attached together with a fiber reinforced layer. The surface structured layers may be the same or may be different. One exemplary embodiment of a reinforced film that includes two of the same type of surface structured layer is schematically illustrated in FIG. 12A. A first brightness enhancing layer 1202 is attached to a first reinforced layer 1204. A second brightness enhancing layer 1206 may be attached to the first brightness enhancing layer 1202 or to the first reinforced layer 1204. In some embodiments, the ridges of the two brightness enhancing layers 1202, 1206 may be oriented perpendicularly to each other, for example if it is desired that the brightness enhancing layers are used to change the direction of the light for both the vertical and horizontal viewing directions of a display system. In other embodiments, an optional additional reinforcing layer 1208 may be included, as is schematically illustrated in FIG. 12B for the reinforced brightness enhancing layer 1210.

Other combinations of surface structured layers may be used. For example, a brightness enhancing layer may be attached to a layer structured with a diffractive surface pattern or to a layer providing optical power.

A surface structured layer, attached to a reinforcement layer, may also be attached to another surface structured layer that itself includes fiber reinforcement. Reinforced surface structured layers are discussed in greater detail in U.S. patent application Ser. No. 11/125,580 and U.S. patent application Ser. No. 11/278258, incorporated herein by reference. A reinforced surface structured layer is an optical layer that includes inorganic fibers within the polymer matrix for reinforcement and that also has at least one of its surfaces structured. One exemplary embodiment of a reinforced film 1300 having a surface structured layer attached to a reinforced surface structured layer is illustrated in FIG. 13. A brightness enhancing layer 1302 is attached to a fiber reinforced layer 1304. A fiber reinforced diffractive surface layer 1306 is attached to the brightness enhancing layer, for example through the use of an adhesive layer 1308.

In the different embodiments of reinforced surface structured film illustrated in FIGS. 6-13, it is important to appreciate that the order of the different layers within the film stack may be different from that illustrated. For example, in the embodiment of film 1000 schematically illustrated in FIG. 10, the reflector layer 1006 may be positioned between the reinforced layer 1004 and the surface structured layer 1002. Also, in all of the examples showing the addition of another optical film, there may be two or more fiber reinforced layers, instead of just a single layer.

### EXAMPLES

Select embodiments of this invention are described below. These examples are not meant to be limiting, only illustrative of some of the aspects of the invention.

All of the following examples of composite film used as the inorganic fiber reinforcement a woven fiberglass produced by Hexcel Reinforcements Corp., Anderson, S.C. The Hexcel 106 (H-106) fibers were received from the vendor with finish applied to the fibers to act as a coupling agent between the fiber and the resin matrix. In the examples, all the H-106 glass fabrics used had a CS767 silane finish. In other systems it may be desirable to add use a glass reinforcement in the greige state that does not have a finish or coupling agent applied to the glass fiber. The refractive index (RI) of the fiber samples listed in Table I were measured with Transmitted Single Polarized Light (TSP) with a 20×/0.50 objective, and Transmitted Phase Contrast Zernike (PCZ) with a 20×/0.50 objective. The fiber samples were prepared for refractive index measurement by cutting portions of the fibers using a razor blade. The fibers were mounted in various RI oils on glass slides and covered with a glass coverslip. The samples were analyzed using the Zeiss Axioplan (Carl Zeiss, Germany). Calibration of the RI oils was performed on an ABBE-3L Refractometer, manufactured by Milton Roy Inc., Rochester, N.Y., and values were adjusted accordingly. The Becke Line Method accompanied with phase contrast was used to determine the RI of the samples. The nominal RI results for the values of n_{D}, the refractive index at the wavelength of the sodium D-line, 589 nm, had an accuracy of ±0.002 for each sample.

Summary information for various resins used in Examples 1-4 is provided in Table I.

TABLE I
Resin Components

| Component | | Resin | Refractive |
|---|---|---|---|
| ID | Manufacturer | Component | Index |
| C1 | Cytec Surface Specialties | Ebecryl 600 | 1.5553 |
| C2 | Sartomer Company | TMPTA | 1.4723 |
| C3 | Ciba Specialty Chemicals | Darocur 1173 | 1.5286 |
| | Corp. | | |
| C4 | Cognis Corp. | Photomer 6210 | |
| C5 | Sartomer Company | THFA (SR285) | |
| C6 | Sartomer Company | HDODA(SR238) | |
| C7 | Ciba Specialty Chemicals | Darocur 4265 | |
| | Corp. | | |

Darocur 1173 and Darocur 4265 are photoinitiators, while THFA (tetrahydrofurfuryl acrylate) is a mono-functional acrylate monomer. The remaining components in Table I are resins that cross-link upon curing. Ebecryl 600 is a Bisphenol-A epoxy diacrylate oligomer.

### Example 1

### BEF Attached to Reinforced Composite Layer

A light-directing, prismatic, brightness enhancing microstructured film (Vikuiti™ Thin-BEF-90/24-II-T, available from 3M Company, St. Paul, Minn.) was attached to a transparent composite using a UV-cured resin acting as a laminating adhesive. In this example, the flat side of the brightness enhancing film was primed and laminated to a pre-made reinforced composite layer containing glass fibers in a polymer matrix. The structure of the finished article was, from bottom to top, i) reinforced composite layer, ii) laminating adhesive and iii) brightness enhancing layer.

The reinforced composite layer was formed using fiber material F1 described above. The refractive index of the F1 glass fibers, having a CS767 surface finish, was 1.551±0.002.

The polymer resin used for the reinforcing layer was a per weight mixture of the following components:

| Component | % wt. |
|---|---|
| C1 | 69.3 |
| C2 | 29.7 |
| C3 | 1.0 |

### The refractive index of the cured composite resin mixture was 1.5517. Therefore, the difference in refractive index between the fibers and the matrix was 0.0007.

The preparation of the transparent composite began by taping a 12″×24″ (30.5 cm×61 cm) sheet of PET to the leading edge of a 12″×20″×¼″ (30.5 cm×50.8 cm×0.6 cm) sheet of aluminum. A sheet of the F1 fiberglass fabric was laid on top of the PET. The fiberglass fabric was covered by another sheet of 12″×24″ PET and its leading edge taped to the leading edge of the aluminum plate. The leading edge of the aluminum plate was placed into hand-operated laminator. The top sheet of PET and the fiberglass were peeled backwards to allow access to the bottom sheet of PET. A bead of resin (6-8 mL) was applied to the bottom sheet of PET near the edge closest to the laminating rolls. The sandwich construction of the glass fiber fabric between the layers of PET was fed through the laminator at a steady rate forcing the resin up through the glass fiber fabric, coating the fibers entirely.

The laminate, while still attached to the aluminum plate, was placed in a vacuum oven and heated to a temperature between 60° C. and 65° C. The oven was evacuated to 27 inches (68.6 cm) of Hg below atmospheric and the laminate degassed for four minutes. The vacuum was released by introducing nitrogen into the oven. The laminate was passed through the laminator once more. The resin was then cured by passing the laminate beneath a UV Fusion “D” lamp operating at 600 W/in (236 W/cm) at a speed of 30 fpm (15 cm/s).

A primer is used to improve the adhesion of the acrylate resin to the bottom side of the brightness enhancing layer. Radiation-graft primers for acrylic coatings are known. One primer was formed of hexanediol diacrylate 97 wt. % and benzophenone wt.3%. For priming sheets of film, three drops of the primer solution were applied to the necessary side of the film and coated using a tissue by wiping. Any excess primer solution was removed by wiping with a clean tissue. The primer coating was cured using a Fusion “D” lamp operating at 600 W/in (236 W/cm) at a line speed of 30 fpm (15 cm/s) in an air atmosphere.

The primed brightness enhancing layer is subsequently attached to the pre-made transparent composite by coating and curing the laminating adhesive between the primed brightness enhancing layer and the reinforced composite layer. The laminating adhesive was formed of a composition of:

| Component | % wt. |
|---|---|
| C4 | 64.4 |
| C5 | 24.7 |
| C6 | 9.9 |
| C7 | 1.0 |

In this example, the reinforced composite layer was attached to the bottom side of the brightness enhancing layer using the following procedure. First, a 12″×24″ (30.5 cm×30.5 cm) sheet of PET was taped to the leading edge of a 12″×20″×¼″ (30.5 cm×50.8 cm×0.6 cm) sheet of aluminum. A primed brightness enhancing layer was laid onto the PET with its primed surface facing upwards. The bottom sheet of PET was carefully stripped away from the pre-made, reinforced composite layer. The pre-made, reinforced composite layer was laid over the brightness enhancing layer, with the exposed face of the composite layer facing the primed face of the brightness enhancing layer. The top PET layer of the reinforced composite layer was then taped to the leading edge of the aluminum plate. The leading edge of the aluminum plate was placed into a hand operated laminator. The reinforced composite layer was pulled backwards to allow access to the brightness enhancing layer. A bead of the laminating adhesive resin, ˜5 mL, was applied to the edge of the brightness enhancing layer closest to the laminating rolls. The sandwich construction was fed through the laminator at a steady rate, coating the brightness enhancing layer and the reinforced composite with the laminating adhesive.

The laminate, still attached to the aluminum plate, was placed in a vacuum oven heated to a temperature between 60° C. and 65° C. The oven was evacuated to 27 inches (68.6 cm) of Hg below atmospheric and the laminate was degassed for four minutes. The vacuum was released by introducing nitrogen into the oven. The laminate was then passed through the laminator again. The laminating resin was cured by passing the laminate beneath a Fusion “D” lamp operating at 600 W/in (236 W/cm) at a speed of 30 fpm (15 cm/s).

### Example 2

### BEF and RP Attached to Reinforced Composite Layer

A sample was prepared in the same manner as discussed above in Example 1 except that the surface structured layer was Vikuiti™ BEF-RP-II 90/24r, which is a brightness-enhanced, reflective polarizer having a prismatic surface, available from 3M Company, St. Paul, Minn. The reinforcing composite layer was made from H-106 fiberglass with CS767 surface finish and 30/70 TMPTA/Ebecrly 600 resin. The composite layer was attached by priming the flat side of the BEF-RP (with the HDODA/BP at 3% solution) and coating and curing the composite layer directly onto the BEF-RP, using similar techniques to those described in Example 1.

### Example 3

### RP+BEF Between Two Reinforced Composite Layers

A prismatically structured, brightness enhancing layer was attached to a multilayer reflective polarizing layer (RP) and was sandwiched between two reinforced composite layers. The prismatically structured layer was a 5-mil (125 μm) thick sheet of monolithic polycarbonate brightness enhancing layer, Vikuiti™ WBEF W818, available from 3M Company, St. Paul, Minn. The reflective polarizing layer was a multilayer polymer reflective polarizer having the same optical layer construction as a sheet of Vikuiti™ DBEF-P2, available from 3M Company, although the skin layers were slightly thinner than the commercial product.

In this example, each side of the RP layer and the unstructured side of the WBEF layer were primed using the same priming technique as described in Example 1. A pre-made fiber reinforced composite layer was attached to each side of the RP layer and the bottom of the WBEF layer was attached to the other side of one of the reinforced composites using an UV-cured laminating adhesive. The structure of the article was, therefore: reinforced composite layer; laminating adhesive; primer; RP; primer; laminating adhesive; reinforced composite; laminating adhesive; primer; WBEF. The reinforced composite layers and the laminating adhesive were the same as those described above for Example 1.

The reinforced composite was attached to the WBEF film using the same procedure as discussed in Example 1 for attaching the reinforced composite layer to the BEF layer.

A different sheet of transparent composite was attached to the RP layer using the following process. The leading edge of a 12″×24″ (30.5 cm×61 cm) sheet of PET was taped to the leading edge of a 12″×20″×¼″ (30.5 cm×50.8 cm×0.6 cm) sheet of aluminum. The sheet of RP was laid onto the PET sheet. A sheet of reinforced composite, still laminated to a single sheet of PET, was laid on top the RP and the leading edge of the laminate taped to the leading edge of the aluminum plate. The leading edge of the aluminum plate was placed into a hand operated laminator. The top sheet of the reinforced composite was peeled backwards to allow access to the layer of RP. A bead of laminating resin (˜5 mL) was applied to the edge of the RP layer closest to the laminating rolls. The sandwich construction was fed through the laminator at a steady rate forcing the laminating adhesive resin between the reinforced composite and the RP. The resin was cured by passing the laminate beneath a Fusion “D” lamp operating at 600 W/in (236 W/cm) at a speed of 30 fpm (15 cm/s). The bottom sheet of PET was carefully stripped away from the RP and set aside.

The PET sheet bearing the reinforced composite on the WBEF layer was placed, with the exposed composite side up, on the aluminum plate and its leading edge was taped down in the manner previously described. The PET sheet bearing the reinforced composite on the RP layer was placed, with the exposed RP layer down, on top of the composite already on the aluminum sheet and its leading edge taped down in the manner previously described. The leading edge of the aluminum plate was placed into a hand operated laminator. The top sheet of reinforced composite and the RP layer were peeled backwards to allow access to the sheet of reinforced composite. A bead of laminating adhesive resin (˜5 mL) was applied to the edge of the reinforced composite closest to the laminating rolls. The sandwich construction was then fed through the laminator at a steady rate forcing the laminating adhesive resin between the reinforced composite and the RP.

The laminating adhesive resin was cured by passing the laminate beneath a UV Fusion “D” lamp operating at 600 W/in (236 W/cm) at a speed of 30 fpm (15 cm/s). Both sheets of the PET were removed from the composite reinforced laminated sandwich of films.

### Example 4

### Integrated BEF and RP with Reinforced Composite Layer

A sample was made as described in Example 1, except that the surface structured layer was PC-BEF, a prismatic brightness enhancing layer formed on a 250 μm thick layer of polycarbonate (PC) having a prism structure with pseudo-random height undulations very similar to that found in Vikuiti-BEF-III 90/50, the only major difference being that the prism tips were rounded to a radius of 7 microns. In addition, the PC-BEF layer had previously been attached to a reflective polarizer layer. The RP layer was the same RP as used in Example 3.

The PC-BEF layer and the reflective polarizer layer were attached using the following procedure. Each side of the RP layer and the unstructured side of the PC-BEF layer were primed using the primer discussed above in Example 1. A pre-made reinforced composite layer was attached to one side of the RP layer and the unstructured side of a PC-BEF sheet was attached to the other side of the RP layer, both using a UV-cured laminating adhesive. The structure of the finished article, therefore, was: reinforced composite layer; laminating adhesive; primer; RP; primer; laminating adhesive; primer; PC-BEF.

The reinforced composite layer was prepared in the same manner as discussed above in Example 1.

The PC-BEF layer was attached to the reflective polarizer layer first by taping a 12″×24″ (30.5 cm×61 cm) sheet of PET to the leading edge of a 12″×20″×¼″ (30.5 cm×50.8 cm×0.6 cm) sheet of aluminum. A layer of PC-BEF was laid onto the PET sheet, with the prismatic structure facing the PET sheet. A primed sheet of RP was laid on top of the PC-BEF sheet. The RP sheet was covered by another sheet of 12″×24″ (30.5 cm×61 cm) PET and its leading edge was taped to the leading edge of the aluminum plate. The leading edge of the aluminum plate was then placed into a hand operated laminator. The top PET sheet and the RP sheet were peeled backwards to allow access to the sheet of PC-BEF. A bead of the laminating resin (˜5 mL) was applied to the PC-BEF sheet near the edge closest to the laminating rolls. The sandwich construction was fed through the laminator at a steady rate forcing the laminating adhesive resin to evenly coat between the films.

The laminate, still attached to the aluminum plate, was cured by passing the laminate beneath a UV Fusion “D” lamp operating at 600 W/in (236 W/cm) at a speed of 30 fpm (15 cm/s).

The bottom PET sheet of a pre-made reinforced composite was stripped away and the top PET sheet of the cured laminate sandwich was stripped away to expose the underlying RP layer. The pre-made reinforced composite was laid, composite side down, on top of the exposed RP layer and the top layer of PET, on the composite, was taped to the leading edge of the aluminum plate. The leading edge of the aluminum plate was placed into a hand operated laminator. The top sheet of reinforced composite and PET were pulled back to allow access to the layer of RP. A bead of laminating adhesive, ˜5 mL, was applied to the edge of the RP closest to the laminating rolls. The laminating adhesive was the same as that described in Example 1. The sandwich construction was fed through the laminator at a steady rate coating the RP layer and the pre-made reinforced composite layer. The resulting laminate, still attached to the aluminum plate, was cured by passing the laminate beneath a Fusion “D” lamp operating at 600 W/in (236 W/cm) at a speed of 30 fpm (15 cm/s). Both remaining sheets of PET were carefully stripped away.

### Example 5

Example 5 was a single sheet of Vikuiti™ Thin-BEF-90/24-II-T, available from 3M Company, St. Paul, Minn., and was used for comparison purposes. This was the same surface structured layer as was used in Example 1.

### Example 6

Example 6 was a single sheet of Vikuiti™ BEF-RP-II 90/24r, a brightness-enhanced reflective polarizer having a prismatic surface available from 3M Company, St. Paul, Minn. This example was used for comparison purposes.

### Example 7

Example 7 was a single sheet of Vikuiti™ DBEF-DTV, a second type of brightness-enhanced reflective polarizer having a prismatic surface available from 3M Company, St. Paul, Minn. This example was used for comparison purposes.

### Sample Testing

Glass-resin composite layers similar to those included in the examples here were evaluated under crossed polarizers and by using a polarimeter with a spectral scanning source. The composite samples were found to have low retardance and low birefringence. The retardance (in nanometers) is defined here as d×(|nₒ−nₑ|), where d is the thickness of the sample, and the quantity (|nₒ−nₑ|) is equivalent to the birefringence or the magnitude of the index difference between the ordinary and extraordinary axes of the sample. Composite layers similar to those made here were found to have retardance values below 2 nm (at 600 nm wavelength), corresponding to birefringence values below 0.0001.

The general relative gain test method used to quantify the optical performance of the inventive optical films is now described. Although specific details are given for completeness, it should be readily recognized that similar results can be obtained using modifications of the following approach. Optical performance of the films was measured using a SpectraScan™ PR-650 SpectraColorimeter with an MS-75 lens, available from Photo Research, Inc, Chatsworth, Calif. The films were placed on top of a diffusely transmissive hollow light box. The diffuse transmission and reflection of the light box can be described as Lambertian. The light box was a six-sided hollow cube measuring approximately 12.5 cm×12.5 cm×11.5 cm (L×W×H) made from diffuse PTFE plates of ˜6 mm thickness. One face of the box is chosen as the sample surface. The hollow light box had a diffuse reflectance of ˜0.83 measured at the sample surface (e.g. ˜83%, averaged over the 400-700 nm wavelength range, box reflectance measurement method described further below). During the gain test, the box is illuminated from within through a ˜1 cm circular hole in the bottom of the box (opposite the sample surface, with the light directed towards the sample surface from the inside). This illumination is provided using a stabilized broadband incandescent light source attached to a fiber-optic bundle used to direct the light (Fostec DCR-II with ˜1 cm diam. fiber bundle extension from Schott-Fostec LLC, Marlborough Mass. and Auburn, N.Y.). A standard linear absorbing polarizer (such as Melles Griot 03 FPG 007) is placed between the sample box and the camera. The camera is focused on the sample surface of the light box at a distance of ˜34 cm and the absorbing polarizer is placed ˜2.5 cm from the camera lens. The luminance of the illuminated light box, measured with the polarizer in place and no sample films, was >150 cd/m². The sample luminance is measured with the PR-650 at normal incidence to the plane of the box sample surface when the sample films are placed parallel to the box sample surface, the sample films being in general contact with the box. The relative gain is calculated by comparing this sample luminance to the luminance measured in the same fashion from the light box alone. The entire measurement was carried out in a black enclosure to eliminate stray light sources. When the relative gain of film assemblies containing reflective polarizers was tested, the pass axis of the reflective polarizer was aligned with the pass axis of the absorbing polarizer of the test system.

The diffuse reflectance of the light box was measured using a 15.25 cm (6 inch) diameter Spectralon-coated integrating sphere, a stabilized broadband halogen light source, and a power supply for the light source all supplied by Labsphere (Sutton, N.H.). The integrating sphere had three opening ports, one port for the input light (of 2.5 cm diameter), one at 90 degrees along a second axis as the detector port (of 2.5 cm diameter), and the third at 90 degrees along a third axis (i.e. orthogonal to the first two axes) as the sample port (of 5 cm diameter). A PR-650 Spectracolorimeter (same as above) was focused on the detector port at a distance of ˜38 cm. The reflective efficiency of the integrating sphere was calculated using a calibrated reflectance standard from Labsphere having ∫99% diffuse reflectance (SRT-99-050). The standard was calibrated by Labsphere and traceable to a NIST standard (SRS-99-020-REFL-51). The reflective efficiency of the integrating sphere was calculated as follows:

Sphere brightness ratio=1/(1−Rₛₚₕₑᵣₑ*R_{standard})

The sphere brightness ratio in this case is the ratio of the luminance measured at the detector port with the reference sample covering the sample port divided by the luminance measured at the detector port with no sample covering the sample port. Knowing this brightness ratio and the reflectance of the calibrated standard (R_{standard}), the reflective efficiency of the integrating sphere, Rₛₚₕₑᵣₑ, can be calculated. This value is then used again in a similar equation to measure a sample's reflectance, in this case the PTFE light box:

Sphere brightness ratio=1/(1−Rₛₚₕₑᵣₑ*Rₛₐₘₚₗₑ)

Here the sphere brightness ratio is measured as the ratio of the luminance at the detector with the sample at the sample port divided by the luminance measured without the sample. Since Rₛₚₕₑᵣₑ is known from above, it is straightforward to calculate Rₛₐₘₚₗₑ. These reflectances were calculated at 4 nm wavelength intervals and reported as averages over the 400-700 nm wavelength range.

The CIE (1931) chromaticity coordinates of the sample and light box assembly are simultaneously recorded by the PR-650 SpectraColorimeter. The resulting chromaticity coordinates, x, y, presented in Table III, give a quantitative measure of color of the light transmitted through the different samples. The values of Δx and Δy show the difference between the (x,y) coordinates measured with and without the film present, i.e. show the color shift due to the film.

The relative gain, g, is calculated by comparing the sample luminance to the luminance measured in the same fashion from the light box alone, i.e.:

g=L_{f}/Lₒ

where L_{f} is the measured luminance with the film in place and Lₒ is the measured luminance without the film. The measurements were carried out in a black enclosure to eliminate stray light sources. When the relative gain of film assemblies containing reflective polarizers was tested, the pass axis of the reflective polarizer was aligned with the pass axis of the absorbing polarizer of the test system. The ‘blank’ luminance measured from the light box alone, with the absorbing polarizer of the test system in place and no samples above the light box, was approximately 275 candelas m⁻². The measured values of relative gain, g, are presented in Table II. As can be seen, the brightness gain in all cases is more than 10% (equivalent to a relative gain of 1.1), is more than 50% (a relative gain of 1.5), and in many cases is more than 100% (a relative gain of 2).

The thickness of a sample was determined from the average of four thickness measurements taken at different positions across the film. The thickness was measured using an EG-233 digital linear gauge made by Ono Sokki (Yokohama, Japan).

TABLE II
Thickness, Relative Gain, and Chromaticity for Examples 1–6.

| Example | Thickness | Relative | | | | |
|---|---|---|---|---|---|---|
| No. | (μm) | gain, g | x | y | Δx | Δy |
| 1 | 113 | 1.593 | 0.4724 | 0.4255 | 0.0021 | −0.0003 |
| 2 | 207 | 2.358 | 0.4731 | 0.4271 | 0.0014 | −0.0019 |
| 3 | 380 | 2.022 | 0.4717 | 0.4270 | 0.0028 | −0.0018 |
| 4 | 408 | 2.240 | 0.4708 | 0.4266 | 0.0037 | −0.0014 |
| 5 | 63 | 1.592 | 0.4725 | 0.4255 | 0.0020 | −0.0003 |
| 6 | 152 | 2.425 | 0.4723 | 0.4271 | 0.0022 | −0.0019 |
| 7 | 638 | 2.118 | 0.4702 | 0.4268 | −0.0043 | 0.0016 |
| Blank | n/a | 1.000 | 0.4745 | 0.4252 | 0 | 0 |

In general, the relative gains of the reinforced brightness enhancing films (Examples 1-4) are comparable to the examples of commercially available, unreinforced, brightness enhancing films (Examples 5 and 6) and no major color changes are evident. It is worth noting the very small difference in relative gain between, Examples 1 and 5. Example 1 uses the same surface structured layer film as Example 5 but has the additional fiber reinforced layer. The relative gains of these two Examples are comparable, indicating that the reinforced composite layer has low light absorption and scattering, which is advantageous for optical film applications such as these where the light may be recycled through the film more than once. Differences between some of the composite optical products are due to varying haze levels and prism geometries.

A test that is commonly used to characterize the performance of optical films is single-pass transmission. This type of transmission measurement does not take into consideration the effect of the film in a light-recycling cavity. Light that strikes the detector in this test has passed through the film only once. Further, the input light is typically directed at an angle that is substantially normal to the plane of the film, and all transmitted light is collected in an integrating sphere regardless of transmission angle. Many common devices test this type of single-pass transmission, including most commercially available haze-meters and UV-Vis spectrometers.

Many efficient brightness-enhancing films and light-redirecting films do not have high single-pass transmission. In particular, when the brightness enhancing structure is directed away from the light source, most brightness enhancing films have low single-pass transmission. This is because the brightness enhancing films are designed to efficiently create brightness enhancement in a recycling backlight by re-directing off-axis light towards the normal while recycling, through retroreflection, the on-axis light that is measured in single pass transmission. The net effect is efficient brightness enhancement in a display system. Thus, when combined with other characterization tests such as the relative gain test, single pass transmission can be used to evaluate the light-recycling efficiency of a prismatic brightness enhancing film. It is, therefore, desirable that brightness enhancing films show low values of single pass transmission values, when interpreted together with other measures, since they indicate high efficiency of retroreflection. High single pass transmission for certain brightness enhancing films is undesirable because it indicates irregularity and light scattering, leading to less efficient brightness enhancement in the completed display system. In some embodiments it is desirable to have a single pass transmission less than 40%, and in other embodiments less than 10%.

Exemplary optical films of the present invention were tested for single-pass transmission (% T) using a Perkin Elmer Lambda 900 UV-Vis Spectrometer (using an approximate average from 450-650 nm). The brightness enhancing structure was located on the side of the film directed away from the light source. Results are shown in Table III below.

TABLE III
Average single-pass transmission from 450–650 nm wavelength

| Example | Ave. % T (single pass) |
|---|---|
| Ex. 1 Thin BEF Composite | 8.5 |
| Ex. 5 Thin BEF Control | 7.9 |

As can be seen, the composite brightness enhancing film showed a very low single pass transmission, indicative of high efficiency brightness enhancement in a display system.

For certain surface structured films, especially brightness enhancing films, it is often desirable to limit the bulk diffusion that occurs within the film. Bulk diffusion is defined as the light scattering that takes place within the interior of an optical body (as opposed to light scattering occurring at the surface of the body). Bulk diffusion of a structured surface material can be measured by wetting out the structured surface using index matching oils and measuring the haze using a standard haze-meter. Haze can be measured by many commercially available haze-meters and can be defined according to ASTM D1003. Limiting the bulk diffusion typically allows the structured surface to operate most efficiently in re-directing light, brightness enhancement, etc. For some embodiments of the current invention, it is desired that bulk diffusion is low. In particular, in some embodiments the haze due to bulk diffusion (Bulk haze) may be less than 30%, in other embodiments less than 10% and in other embodiments less than 1%.

Bulk diffusion for Example 1 and certain other film samples was measured by wetting out the structured surfaces using certified refractive index matching oils made by Cargille (Series RF, Cat. 18005) and wetting out the films against a glass plate. The wet-out films and the glass plate were then placed in the light path of a BYK Gardner Haze-Gard Plus (Cat. No. 4725) and the haze recorded. In this case, the haze is defined as the fraction of light transmitted that is scattered outside an 8° cone divided by the total amount of light transmitted. The light is normally incident on the film.

The measured values of bulk haze, i.e. the haze arising from propagation within the bulk of the polymer matrix, rather than from any diffusion occurring at the surface of the film, are shown below in Table IV. The film of Example 1 was wet-out using an oil having refractive index of 1.55. All other prism samples were wet-out using oils of index 1.58. As can be seen the sample films showed a haze of less than 30%, and less than 10%.

TABLE IV
Bulk Haze Measurements

| | Haze (due to bulk |
|---|---|
| Sample | diffusion) % |
| Ex. 1 Thin BEF-II Composite | 1.2 |
| Ex. 5 Thin BEF-II-T | 0.49 |
| Blank (Glass plate only) | 0.2 |

### Mechanical Properties

The glass transition temperature of a film sample was measured using a TA Instruments Q800 series Dynamic Mechanical Analyzer (DMA) with film tension geometry. Temperature sweep experiments were performed in dynamic strain mode over the range of −40° C. up to 200° C. at 2° C./min. The storage modulus and tan delta (loss factor) were reported as a function of temperature. The peak of the tan delta curve was used to identify the glass transition temperature, T_{g}, for the films. The T_{g} was measured on a composite layer very similar to that used in Example 1 and produced a value of 71° C. The measured T_{g} on a corresponding sample of the same resin (with no reinforcement) was 90° C. Variability is due to measurement factors. The resin materials used for the composite layers had substantially the same T_{g} for all of the examples described here. In some embodiments it may be desirable for the value of T_{g} to be less than 120° C.

The storage modulus and stiffness (in tension) were measured with Dynamic Mechanical Analysis (DMA) using a TA instruments model# Q800 DMA with film tension geometry. Terminology relating to DMA testing can be defined according to ASTM D-4065 and ASTM D-4092. Reported values are at room temperature (24° C.). The stiffness results are summarized in Table V. The measurements were made at a temperature in the range 24° C.-28° C. The table shows the marked increase in storage modulus which can be obtained using the composite materials. Storage modulus is of greater importance because it provides a thickness-independent measure of the film properties. Some variability in these data is to be expected both from the test method and the lab-scale prototyping of the composite samples.

These high values of tensile modulus and stiffness can be considered to correspond to potential bending stiffness as well, depending on final article construction and geometry: proper placement of the high-modulus layers results in an article having high bending stiffness. Higher stiffness enables ease of handling, thinner and lighter displays, and better display uniformity (through less warp or bending of optical components of the display). The actual performance of the final article will depend on the arrangement of the fibers and the final geometry of the article. For example, it may be desirable for some applications to construct ‘balanced’ articles, e.g. where there is either a single central composite layer or two symmetrically opposed composite layers, so that the material will not have a tendency to bend or curl in a given direction upon curing or heating. The composite samples tested here are substantially unbalanced in their construction. In some applications, the ‘unbalanced’ constructions of the present invention also provide utility due to their increased stiffness and modulus. There also may be processing, cost, thickness, weight, and optical performance advantages to using an unbalanced construction, which may require fewer composite layers, depending on the details of the intended application and article construction.

Table V lists the sample number along with a brief description of the sample. The table also lists the orientation of the measurements relative to the pass or block axes of the polarizer, or to the direction relative to the web as is manufactured on a machine. The direction “machine” corresponds to the down-web direction while the direction “transverse” corresponds to the direction across the web. The table also lists the average storage modulus, the average stiffness, and the thickness.

TABLE V
Storage Modulus and Stiffness values measured for some
representative samples.

| | | Polarizer or | | Storage | |
|---|---|---|---|---|---|
| | | film | Stiffness | Modulus | Thickness |
| Ex. No. | Brief Description | orientation | (10⁴ N/m) | (MPa) | (μm) |
| 1 | Reinforced Thin BEF | machine | 23.2 | 7215 | 97 |
| 5 | Thin BEF control | machine | 8.90 | 4512 | 62 |
| 1 | Reinforced Thin BEF | transverse | 28.4 | 7437 | 97 |
| 5 | Thin BEF control | transverse | 10.7 | 5296 | 62 |
| 2 | Reinforced BEF-RP | pass | 24.3 | 5554 | 150 |
| 6 | BEF-RP control | pass | 9.89 | 2677 | 120 |
| 2 | Reinforced BEF-RP | block | 32.8 | 6746 | 150 |
| 6 | BEF-RP control | block | 15.5 | 4171 | 120 |
| 3 | Reinforced WBEF/DBEF | block | 54.0 | 4427 | 360 |
| 4 | Reinforced PC-BEF/DBEF | block | 47.9 | 3670 | 410 |
| 7 | DBEF-DTV control | block | 54.2 | 2537 | 630 |

### Film Combinations

Spatially periodic patterns can sometimes create undesirable Moire effects when combined with other periodic patterns at certain specific spatial frequencies and angular relationships. Thus, in some case it may be desirable to adjust the spacing, arrangement, or angular bias of the reinforcing fibers in order to minimize Moire patterns created between multiple composite layers, between composite layers and any structured film surfaces (of the same or adjacent films), or between composite layers and any display system elements such as pixels, light-guide dot patterns, or LED sources. Also, in cases where the index matching of the reinforcing fibers is nearly perfect and the composite layers are nearly perfectly smooth, Moire patterns should not occur.

Many of these composite optical articles can be advantageously combined into assemblies. One example of an assembly is “crossed-BEF” configuration, where two brightness enhancing films are placed adjacent one another such that their prism grooves are approximately orthogonal, with the prismatic surface of one film adjacent the non-prismatic surface of the other. Many different advantageous combinations of optical films may be replicated using fiber reinforced optical films, combining the enhanced mechanical properties of the composite films with the advantageous optical properties of the film assemblies. An inexhaustive list of exemplary embodiments of these assemblies includes:
1. Reinforced brightness enhancing film (e.g. Example 1) crossed with a reinforced brightness enhancing layer integrated with a reflective polarizer layer (e.g. Examples 2-4).
2. Unreinforced brightness enhancing film (e.g. Examples 5-6) crossed with a reinforced brightness enhancing integrated with reflective polarizer layer (e.g. Examples 2-4).
3. Reinforced brightness enhancing film (e.g. Example 1) crossed with a reinforced brightness enhancing film (e.g. Example 1)
4. Unreinforced brightness enhancing film (e.g. Examples 5-6) crossed with a reinforced brightness enhancing film (e.g. Example 1).
5. Reinforced brightness enhancing film (e.g. Example 1) crossed with a reinforced brightness enhancing film (e.g. Example 1) and a reinforced reflective polarizer.
6. Unreinforced brightness enhancing film (e.g. Examples 5-6) crossed with a reinforced brightness enhancing film (e.g. Example 1) and a reinforced reflective polarizer.
7. Reinforced brightness enhancing film (e.g. Example 1) configured with a reinforced reflective polarizer.
8. Reinforced brightness enhancing film (e.g. Example 1) configured with an unreinforced reflective polarizer.
9. Reinforced turning film configured with a reinforced reflective polarizer.

For illustrative purposes, some of these film combinations/assemblies were measured using the same relative gain test method described previously. The tested combinations included i) a reinforced BEF film crossed with a reinforced BEF layer, ii) a reinforced BEF layer crossed with a reinforced brightness enhancing layer integrated with a reflective polarizer layer and iii) an unreinforced Thin BEF II layer crossed with a reinforced brightness enhancing layer integrated with a reflective polarizer layer. These exemplary combinations were compared to various combinations of the commercially available layers. The results are presented in Table VI below.

TABLE VI
Characteristics of Exemplary Film Assemblies

| Film combinations | | | CIE Chromaticity | |
|---|---|---|---|---|
| Bottom Film | Top Film | Rel. gain, g | x | y |
| Ex. 1 | Ex. 1 | 2.368 | 0.4722 | 0.4271 |
| Thin BEF II | Thin BEF II | 2.3933 | 0.4707 | 0.4262 |
| Thin BEF II | BEF-RP | 3.180 | 0.4716 | 0.4287 |
| Ex. 1 | Ex. 2 | 3.036 | 0.4734 | 0.4292 |
| Thin BEF II | Ex. 2 | 3.124 | 0.4720 | 0.4285 |
| None | None | 1.000 | 0.4744 | 0.4252 |

In general, the relative gains of the composite examples are approximately the same as the comparative examples and only small color changes are evident. Also, it is worth noting the very small differences in gain between, for example, crossed Example 1 films and crossed Thin-BEF-II films. This indicates that the composite substrate of Example 1 has very low light absorption and scattering, which is advantageous for configurations in which the light is recycled through the film multiple times.

The present invention should not be considered limited to the particular examples described above, but rather should be understood to cover all aspects of the invention as fairly set out in the attached claims. Various modifications, equivalent processes, as well as numerous structures to which the present invention may be applicable will be readily apparent to those of skill in the art to which the present invention is directed upon review of the present specification. The claims are intended to cover such modifications and devices.

We claim:

1. An optical film, comprising:
a first layer, comprising inorganic fibers embedded within a polymer matrix, light propagating through the first layer being subject to a bulk haze of less than 30%; and
a second layer attached to the first layer, the second layer comprising a polymer layer having a structured surface.

2. An optical film as recited in claim 1, wherein the bulk haze is less than 10%.

3. An optical film as recited in claim 2, wherein the bulk haze is less than 1%.

4. An optical film as recited in claim 1, further comprising an adhesive layer adhesively attaching the first and second layers.

5. An optical film as recited in claim 1, wherein the polymer matrix is cross-linked with the polymer of the second layer.

6. An optical film as recited in claim 1, wherein the structured surface comprises a brightness enhancing layer surface.

7. An optical film as recited in claim 1, wherein the structured surface comprises at least one of i) a plurality of prismatic ribs, ii) a plurality of retroreflecting elements and iii) one or more lenses.

8. An optical film as recited in claim 7, wherein the one or more lenses comprise one or more refracting lenses.

9. An optical film as recited in claim 7, wherein the one or more lenses comprise at least one Fresnel lens.

10. An optical film as recited in claim 1, wherein the structured surface comprises at least one of a diffractive surface and a light collecting surface.

11. An optical film as recited in claim 1, wherein a refractive index difference between the inorganic fibers and the polymer matrix is less than 0.02.

12. An optical film as recited in claim 11, wherein the refractive index difference is less than 0.01.

13. An optical film as recited in claim 1, further comprising a third layer attached to one of the first and second layers.

14. An optical film as recited in claim 13, wherein the third layer comprises a fiber reinforced layer having inorganic fibers embedded within a polymer matrix.

15. An optical film as recited in claim 13, wherein the third layer is attached to the structured surface.

16. An optical film as recited in claim 13, wherein the third layer is attached to the second layer.

17. An optical film as recited in claim 13, wherein the third layer comprises one of a reflective layer, a transmissive optical layer, a diffusive layer, a layer having a structured surface, and a polarizer layer.

18. An optical film as recited in claim 17, wherein the polarizer layer comprises a reflective polarizer layer.

19. An optical film as recited in claim 17, wherein the polarizer layer comprises an absorbing polarizer layer.

20. An optical film as recited in claim 1, wherein the polymer matrix comprises a thermosetting polymer.

21. An optical film as recited in claim 1, wherein the polymer matrix comprises a thermoplastic polymer.

22. An optical film as recited in claim 1, wherein the polymer matrix comprises a polymer having a value of T_{g} less than 120° C.

23. An optical film as recited in claim 1, wherein a single pass transmission through the film for light directed substantially normally to a surface of the film facing away from the structured surface is less than 40%.

24. An optical film as recited in claim 23, wherein the single pass transmission is less than 10%.

25. An optical film as recited in claim 1, wherein the film provides a brightness gain of at least 10%.

26. An optical film as recited in claim 1, wherein light directed to the film, having a principal ray at an angle of more 30° to a film normal, is transmitted out of the film with the principal ray propagating at an angle of less than 25° to the film normal.

27. An optical film as recited in claim 1, wherein when light is incident on the optical film, the light having a principal ray propagating in a first direction when incident on the optical film, the light is transmitted out of the film with the principal ray propagating in a second direction different from the first direction by at least 5°.

28. A display system, comprising:
a display panel;
a backlight; and
a reinforced film positioned between the display panel and the backlight, the reinforced film comprising a first layer, comprising inorganic fibers embedded within a polymer matrix, light propagating through the first layer being subject to a bulk haze of less than 30%, and a second layer attached to the first layer, the second layer comprising a polymer layer having the structured surface.

29. A display system as recited in claim 28, wherein the display panel comprises a liquid crystal display panel.

30. A display system as recited in claim 28, further comprising at least one of a diffusing layer and a reflecting polarizer layer disposed between the display panel and the backlight.

31. A display system as recited in claim 28, wherein the backlight comprises one or more light sources.

32. A display system as recited in claim 31, wherein the light sources comprise light emitting diodes.

33. A display system as recited in claim 31, wherein the light sources comprise fluorescent lights.

34. A display system as recited in claim 28, further comprising a control unit coupled to control an image formed by the display panel.

35. A method of manufacturing an optical film, comprising:
providing a first layer having a structured surface;
providing a fiber reinforced layer comprising inorganic fibers embedded within a polymer matrix, light propagating through the fiber reinforced layer being subject to a bulk haze of less than 30%; and
attaching the fiber reinforced layer to the first layer.

36. A method as recited in claim 35, wherein attaching the fiber reinforced layer comprises disposing an adhesive layer on at least one of the first layer and the fiber reinforced layer, and pressing the first layer and the fiber reinforced layer together.

37. A method as recited in claim 36, further comprising curing the adhesive layer.

38. A method as recited in claim 35, wherein the first layer comprises a polymer resin, wherein at least some of the polymer matrix of the fiber reinforced layer is not completely cross-linked, and further comprising disposing the fiber reinforced layer on the first layer and cross-linking the polymer matrix with polymer material of the first layer.
